(19) United States
(12) Patent Application Publication
(10) Pub. No.: US 2026/0091515 A1
(43) Pub. Date: Apr. 2, 2026

(54) AUXETIC SHAPE MEMORY MATERIAL (SMM) DEFORMABLE STRUCTURE

(71) Applicant: Toyota Motor Engineering & Manufacturing North America, Inc., Plano, TX (US)

(72) Inventors: Yuyang Song, Ann Arbor, MI (US); Shinnosuke Shimokawa, Ann Arbor, MI (US); Koray Benli, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/904,561

(22) Filed: Oct. 2, 2024

(51) Int. Cl. B25J 15/12

(52) U.S. Cl. CPC B25J 15/12

(57) ABSTRACT

Structures, systems, methods, and other embodiments described herein relate to selectively deformable bodies. In one embodiment, a deformable structure includes an expandable tube of a shape memory material (SMM) arranged in an auxetic pattern. The SMM becomes deformable responsive to an activation input. The deformable structure also includes a first heating element within an interior volume of the expandable tube. The first heating element activates the SMM. The deformable structure also includes an inflatable structure within the interior volume of the expandable tube, to selectively deform the SMM when activated.

### TECHNICAL FIELD

The subject matter described herein relates, in general, to structures and, more particularly, to selectively deformable structures that include shape memory material (SMM) in an auxetic pattern.

### BACKGROUND

Biomimetics is concerned with emulating or replicating processes found in nature. One particular example involves the development of devices that replicate the motion of human fingers. However, replicating the motion of human hands is challenging. Some biomimetic devices are formed of metal and/or plastic structures with mechanical linkages and joints. Other robotic devices, such as soft robotic devices, utilize flexible materials like silicon rubber to replicate the human hand and/or fingers.

### SUMMARY

In one embodiment, example structures, systems, and methods relate to operating a robotic gripping device. In one embodiment, a deformable structure is described. The deformable structure includes an expandable tube of a shape memory material (SMM) arranged in an auxetic pattern. The SMM becomes deformable responsive to an activation input. The deformable structure also includes a first heating element within an interior volume of the expandable tube. The first heating element activates the SMM. The deformable structure also includes an inflatable structure within the interior volume of the expandable tube. The inflatable structure selectively deforms the SMM when activated.

In one embodiment, a system is described. The system includes a deformable structure. The deformable structure includes an expandable tube of SMM arranged in an auxetic pattern. The SMM becomes deformable responsive to an electrical current. The deformable structure also includes a first heating element within an interior volume of the expandable tube. The first heating element activates the SMM. The deformable structure also includes an inflatable structure within the interior volume of the expandable tube. The inflatable structure selectively deforms the SMM when activated. The system also includes a power source coupled to the first heating element to apply the electrical current to the SMM and an electrical pump to selectively inflate the inflatable structure.

In one embodiment, a method is described. The method includes applying an activation input to an expandable tube of SMM arranged in an auxetic pattern. The SMM becomes deformable responsive to the electrical current. The method also includes deforming the expandable tube by inflating an inflatable structure that is within an interior volume of the expandable tube. The method also includes setting the expandable tube in a deformed shape by disengaging the electrical current.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIGS. 1A and 1B are isometric views of a deformable structure with SMM in a non-uniform auxetic pattern and an inflatable balloon.

FIGS. 2A and 2B are isometric views of a deformable structure with SMM in a non-uniform auxetic pattern and an inflatable sleeve.

FIG. 3 is a top view of a planar layer of SMM material in a non-uniform auxetic pattern.

FIGS. 4A and 4B are views of the layer of SMM material in a non-uniform auxetic pattern and heating elements.

FIGS. 5A and 5B are isometric views of a deformable structure with SMM in a segmented arrangement and an inflatable ballon.

FIGS. 6A and 6B are isometric views of a deformable structure with SMM in a segmented arrangement and an inflatable sleeve.

FIG. 7 is an exploded view of a segment of a deformable structure.

FIG. 8 is a top view of an unrolled deformable structure with SMM in a tiled arrangement.

FIG. 9 illustrates a flowchart for one embodiment of a method that is associated with manipulating a deformable structure.

FIG. 10 illustrates a flowchart for one embodiment of a method that is associated with manipulating a deformable structure with SMM in a non-uniform auxetic pattern.

FIG. 11 illustrates a flowchart for one embodiment of a method that is associated with manipulating a deformable structure with SMM in a segmented arrangement.

FIG. 12 depicts a system for manipulating a deformable structure.

### DETAILED DESCRIPTION

Structures, systems, and methods described herein relate to a deformable body that may emulate the motion of a human finger. As described above, biomimetics is a field of science that studies the motion of living organisms, such as humans, and develops devices that emulate, replicate, or mimic that motion. In one particular example, efforts have been made to replicate the movement of a human finger, more particularly multiple human fingers, to replicate complex gripping motions. However, this endeavor is fraught with challenges. For example, rigid linkages and hinges are bulky, heavy, and complex and may not replicate the contoured grip of a human hand. Other devices, such as soft robotic devices, use soft materials, such as silicon rubber, to replicate this motion. Silicon rubber devices may not provide sufficient stiffness to grasp an object.

Accordingly, the present specification describes a deformable or morphable body that provides increased stiffness over soft robotics and is less rigid, heavy, and complex than mechanical linkage systems.

Specifically, the present system implements a hollow tube formed of a shape memory material in an auxetic pattern. As used in the present specification and the appended claims, a structure with an “auxetic” pattern has a negative Poisson's ratio, meaning that axial elongation, rather than causing transversal compression, results in transversal elongation. Put another way, a material with an auxetic pattern has a surface area that increases responsive to an applied tensile force, such as tensile pulling or expansive pressure from an internal surface (i.e., when inflating a balloon).

The tube is made of a shape memory material (SMM). In general, a shape memory material is any material that changes shape when an activation input, such as heat, is provided to the SMM. In this particular example, the SMM becomes more pliable and deformable when the activation input (e.g., heat) is provided. Examples of SMMs include shape memory alloys (SMA) and shape memory polymers (SMP). The SMM may be heated by the Joule effect by passing an electrical current through the SMM. The SMM increases in temperature in response to the electrical current. That is, the SMM heats up in response to the resistance of the SMM to the electrical current. In some implementations, the SMM receives the electrical current from a computing device and/or a power source. Upon reaching a glass transition temperature, T_{g}, the SMM changes from a first state (i.e., generally rigid and stiff) to a second state (i.e., generally pliable and deformable). In this second state, the SMM is more responsive to applied forces. Given that the SMM is arranged in an auxetic pattern, responsive to an outward force from within a cavity of the tube, the SMM material may expand when in the second state. Following deformation, the electrical current may be removed and the SMM material returns to a rigid and stiff state. Thus, the structure may retain its deformed state. Accordingly, the tube is deformable and may be set or locked into the deformed state.

In an example, the deformable structure may be arranged to exhibit a bending motion. That is, the expandable tube of SMM may be arranged in an auxetic pattern to provide localized bending of the tube at a predetermined location. In one example, to effectuate the bending motion, the SMM of the tube may be arranged in a non-uniform auxetic pattern, with different regions arranged in different auxetic patterns that deform to different degrees based on the respective auxetic pattern. For example, the SMM in a region that defines an inner edge of a bending joint may be arranged in an auxetic pattern that deforms less as compared to the SMM in a region that defines an outer edge of the bending joint, which outer region SMM may be arranged in an auxetic pattern that deforms more. This disparate deformation may result in bending towards the less flexible region and away from the more flexible region.

In another example, a heating element may selectively heat regions of the SMM that correspond to the outer edge of the bending joint. In this example, responsive to an applied outward pressure, the heated portions expand while unheated portions on the inner edge of the bending joint do not. This may result in bending the deformable structure towards the unheated portions and away from the heated portions.

In either case, such a deformable structure may be used in various applications. For example, the deformable structure may form part of a robotic hand or a robotic gripping device. That is, the deformable structure may replicate the human finger such that multiple deformable structures could be combined to form a robotic device that mimics the movement of a human hand.

In this way, the disclosed structures, systems, and methods may replicate human finger movement in a lightweight, reversible, customizable, and effective manner. As such, the tube can be formed into different configurations (e.g., a bent configuration) without using heavy linkage/hinge assemblies and doing so with sufficient rigidity to grip objects.

In the description that follows, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

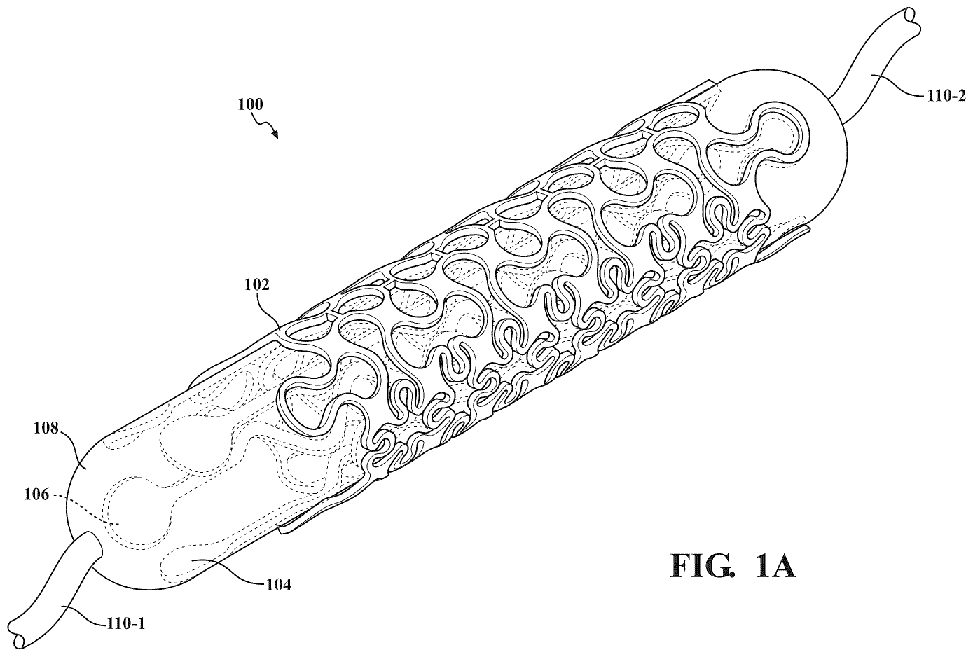

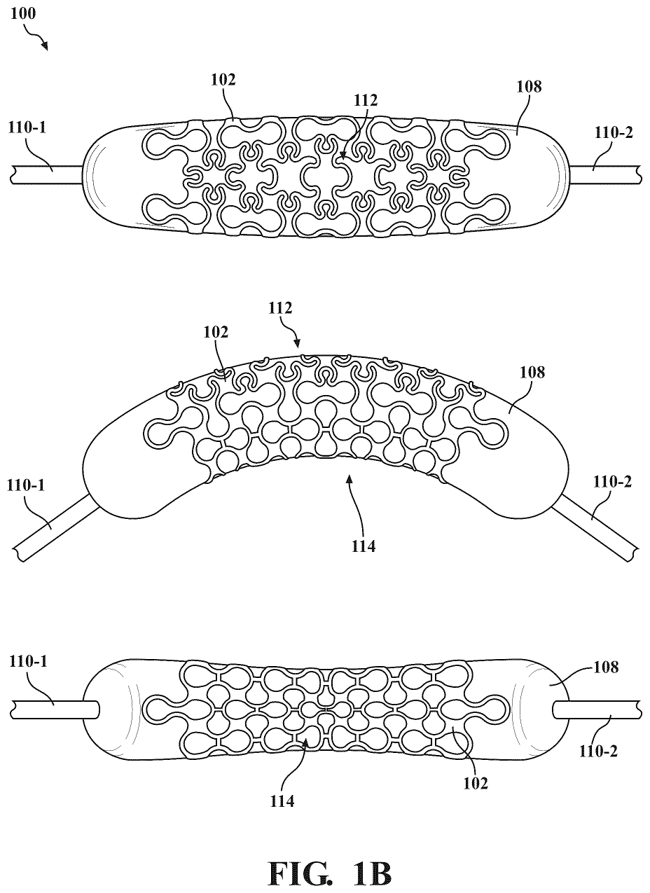

Turning now to the figures, FIGS. 1A and 1B are isometric views of a deformable structure 100 with SMM in a non-uniform auxetic pattern and an inflatable balloon 108. Specifically, FIG. 1A depicts the deformable structure 100 in a non-deformed state before the application of 1) an activation input (e.g., an electrical current) and 2) a deforming force (e.g., resulting from inflating the inflatable structure). FIG. 1B depicts the deformable structure 100 in a deformed state following the application of 1) the activation input and 2) the deforming force. For simplicity, heating elements 104 and 106 are omitted in FIG. 1B.

The deformable structure 100 includes an expandable tube 102 of SMM arranged in an auxetic pattern. As described above, SMM becomes deformable responsive to an activation input. That is, SMM changes physical properties when an activation input is provided. In general, the SMM may provide desired actuation characteristics. For instance, the SMM may be configured such that when an activation input is provided, the SMM changes from a rigid state to a morphable, deformable, or pliable state. Accordingly, if a deforming force is applied to the expandable tube 102 when the SMM is in the deformable state, the expandable tube 102 may change shape responsive to the deforming force. The deformation resulting from the deforming force may be set by removing the activation input. That is, the SMM may be structured such that when the activation input is removed, the SMM returns to its original state, in this case, a rigid and stiff state. As such, he deformable structure 100 may be locked in the deformed orientation.

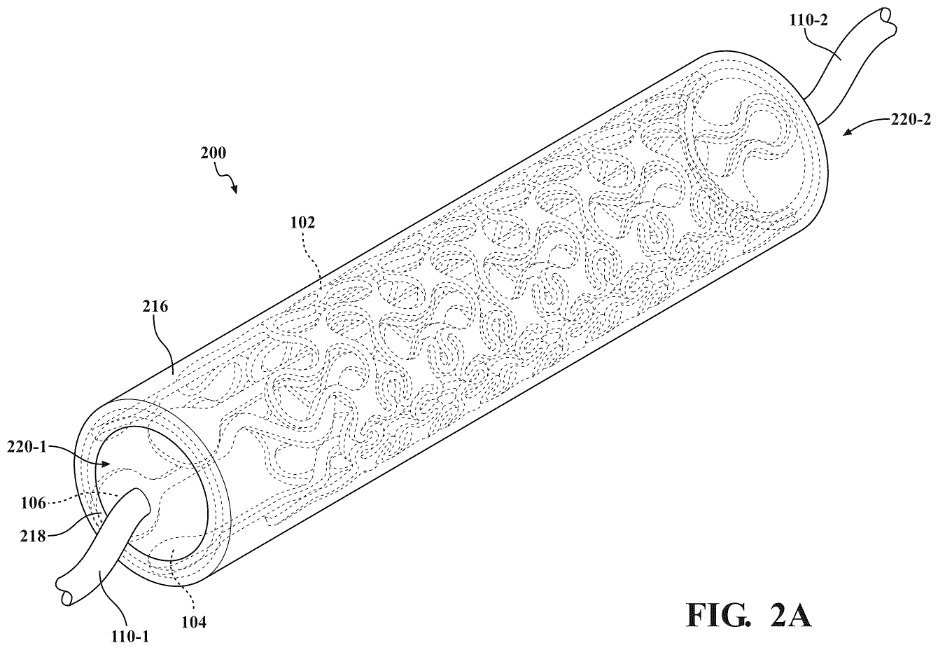

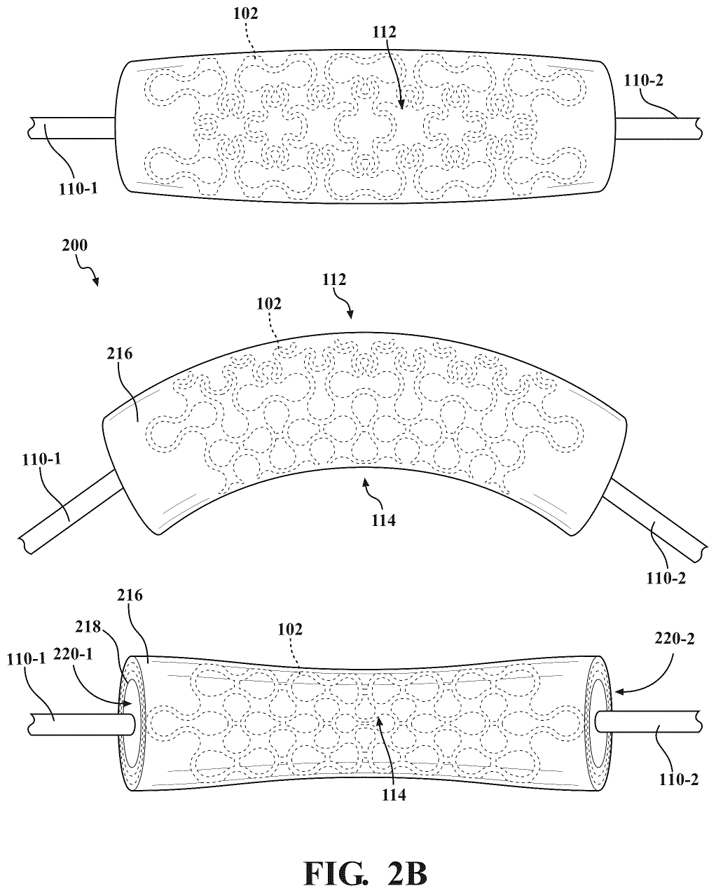

The SMM may be such that, when re-activated, the SMM returns to a pre-activated state and form absent any deforming force. In the context of the present deformable structure 100, when the activation input is applied and 1) the deformable structure 100 is in the deformed state as depicted in FIGS. 1B and 2) the deforming force is not present, the deformable structure 100 may return to its pre-activated form, as depicted in FIG. 1A. That is, the SMM includes shape memory properties where, absent any applied force, the structure of the SMM returns to a pre-deformed state when activated.

In an example, the activation input is heat that is generated by passing an electrical current through heating elements 104 and 106. That is, the SMM of the expandable tube 102 may be heated by the Joule effect by passing an electrical current through the wires (i.e., the heating elements 104 and 106). The SMM changes from a rigid state to a deformable and pliable state upon changing phase, for example, by being heated to a glass transition temperature T_{g}. The passing of an electric current through the SMM to provide heat generated by electrical resistance may generate a change to the phase or crystal structure transformation (i.e., twinned martensite, detwinned martensite, and austenite), resulting in a change of the properties of the SMM. Upon reaching the glass transition temperature, T_{g}, the SMM changes state (i.e., from a rigid, stiff state to a deformable and pliable state).

As depicted in FIG. 1A, the SMM of the expandable tube 102 may be arranged in an auxetic pattern. As described above, an auxetic pattern exhibits a negative Poisson's ratio, meaning that axial elongation, rather than causing transversal compression, results in transversal elongation. Put another way, a material with an auxetic pattern has a surface area that increases responsive to an applied tensile force, such as tensile pulling or expansive pressure from an internal surface (i.e., when inflating a balloon 108). The result of this auxetic structure is that, responsive to a deforming force, such as when the balloon 108 is inflated, the expandable tube 102 expands.

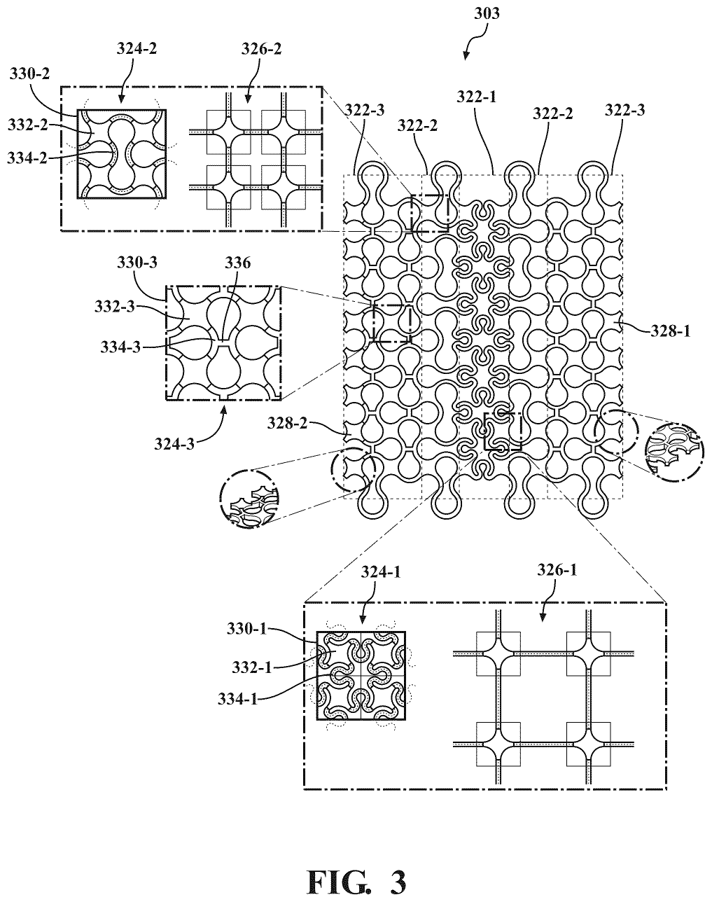

As described above, the expansion of the expandable tube 102 may be controlled to generate a desired deformation. Specifically, the expandable tube 102 may be arranged to exhibit a bending deformation, as depicted in FIG. 1B. This motion may be facilitated in a variety of ways. In the example depicted in FIG. 1A-2B, this is carried out via the non-uniformity of the expandable tube 102. For example, as depicted in greater detail in FIG. 3, the expandable tube 102 is divided into regions, with portions of the SMM in different regions arranged in different auxetic patterns. Responsive to the activation input, different portions of the SMM deform to different degrees based on the different auxetic patterns. For example, as depicted in FIG. 1B, a more constrained region of the expandable tube 102 may deform to a lesser degree than a less constrained region of the expandable tube 102. To generate a bent structure, as depicted in FIG. 1B, the SMM in an outer region 112 of the expandable tube 102 may be in a less constrained auxetic pattern (i.e., a greater possible deformation), and the SMM in an inner region 114 of the expandable tube 102 may be in a more constrained auxetic pattern (i.e., lesser possible deformation). The resulting deformation, as depicted in FIG. 1B, may be a bending motion towards the more constrained region and away from the less constrained region. Note that the terms “lesser” and “greater” in this context refer to the constraint/deformation of the different regions with respect to one another region.

Note that while FIG. 1A depicts an expandable tube 102 that is cylindrical and elongated in the undeformed state, the expandable tube 102 may have a variety of cross-sectional shapes (e.g., rectangular, triangular, ovular, etc.) and may have any variety of undeformed shapes (e.g., curved).

As described above, the SMM may change state responsive to an applied activation input, which activation input may be heat. Accordingly, the deformable structure 100 includes physical elements that provide the activation input. Specifically, the deformable structure 100 includes a first heating element 104, and in some cases a second heating element 106, within an interior volume of the expandable tube 102. The heating elements 104 and 106 activate the SMM. As depicted in FIG. 1A, the heating elements 104 and 106 may form a cylindrical structure adjacent to the cylindrical structure of the expandable tube 102.

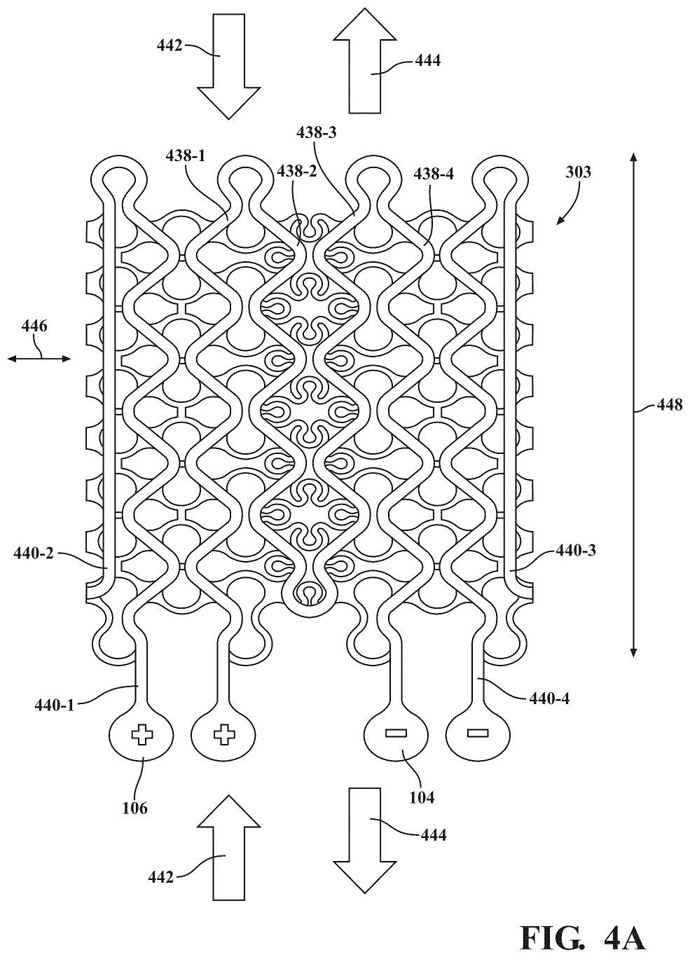

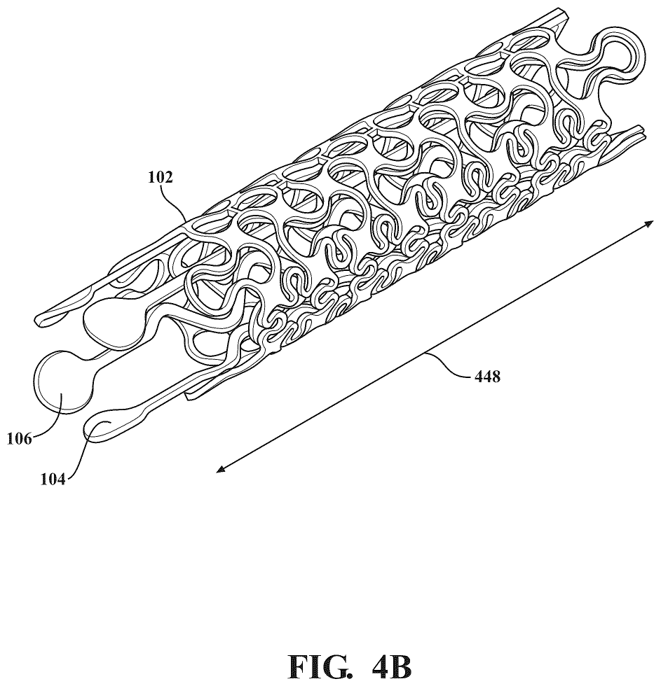

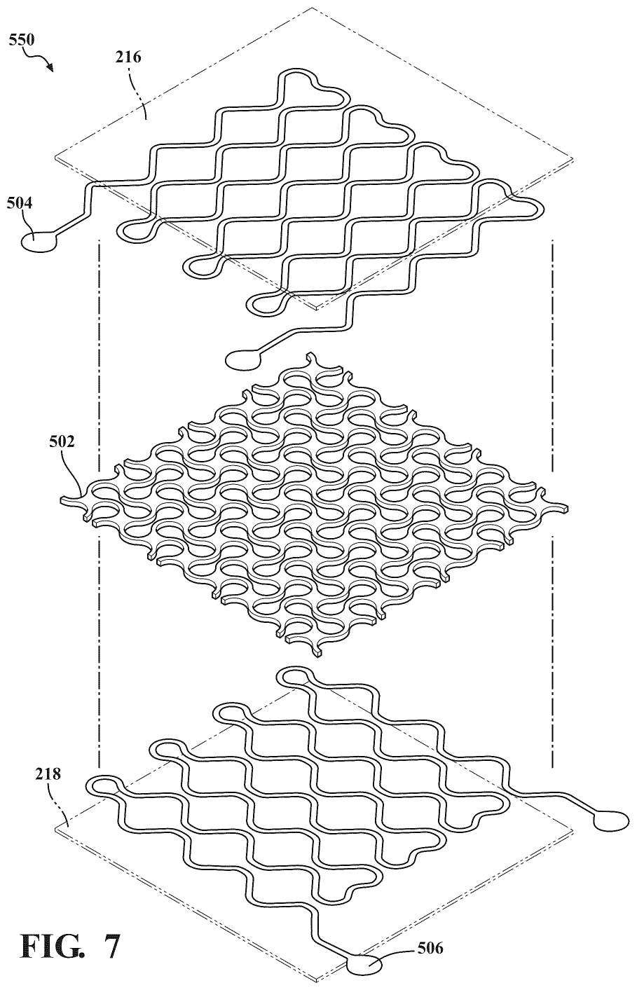

The heating elements 104 and 106 may be electrical wires that pass an electrical current. The electrical wires heat up in response to the electrical current, which heat transfers to the adjacent SMM, placing it in an activated (i.e., deformable and pliable) state. By disengaging the electrical current, the expandable tube 102 is de-activated or returned to its initial state (e.g., rigid and stiff). Additional details regarding the heating elements 104 and 106 are provided below in connection with FIGS. 4A, 4B, and 7.

In a particular example, the heating elements (i.e., the first heating element 104 and the second heating element 106) may be attached to the inflatable structure. For example, as depicted in FIG. 1A, the heating elements 104 and 106 may be formed or adhered to an interior surface of the balloon 108. In another example, the heating elements 104 and 106 may be formed or adhered to an exterior surface of the balloon 108. In another example, the heating elements 104 and 106 may be formed within a thickness of the balloon 108.

As described above, when in a deformable and pliable state, the SMM may be deformed by an applied force. In an example, the deforming force is a force that pushes out on the expandable tube 102 from the interior cavity. Specifically, the deformable structure 100 includes an inflatable structure within the interior volume of the expandable tube 102. The inflatable structure deforms the SMM when the SMM is activated (i.e., from the activation input). The deformable structure 100 may include an inlet hose 110-1, through which the air or other fluid may be introduced into the inflatable structure.

The inflatable structure may take various forms. For example, as depicted in FIGS. 1A and 1B, the inflatable structure may be a balloon 108 disposed within the interior volume of the expandable tube 102. As air or another fluid is introduced into the balloon 108 from the inlet hose 110-1, the balloon 108 expands, generating an outwardly directed force on the balloon 108 walls. This force is transferred to the expandable tube 102, which, because of the applied electrical current from the heating elements 104 and 106, is deformable and expands responsive to the applied force. In an example, air or fluid may be removed from the balloon 108 via the inlet hose 110-1 or an outlet hose 110-2.

As described above and as depicted in FIG. 1B, given the auxetic nature of the expandable tube 102, the tube itself expands. Moreover, given the non-uniform nature of the auxetic patterns of the SMM on the expandable tube 102, the tube may expand non-uniformly. Additional details regarding the modality of providing non-uniform deformation are described below in connection with FIG. 3.

Once the deformable structure 100 is deformed as desired, the activation input from the heating elements 104 and 106 may be disengaged. If the activation input is disengaged while the balloon 108 is still inflated, the deformable structure 100 will remain deformed if the balloon 108 is later deflated. However, if the deforming force is removed (i.e., the balloon 108 is deflated) while the activation input is provided, the deformable structure 100 may return to its undeformed state. Put another way, the SMM remembers its original form (i.e., the elongated form depicted in FIG. 1A) and will return to such when an activation input is applied without a deforming force. The application of the deforming force when the activation energy is applied allows the deformable structure 100 to change shape.

As such, the deformable structure 100 of the present specification provides a device that may replicate the bending movement of a human finger via the non-uniformly arranged SMM of an expandable tube 102. As described above, the expandable tube 102 may be arranged such that the deformed state of the expandable tube 102 may be locked. When set or locked, the deformable structure 100 by itself or, when used with other deformable structures 100, may be able to perform various operations, such as grasping objects. The object may be released by removing the deforming force (i.e., deflating the balloon 108) and applying the activation energy to the one or more deformable structures 100.

FIGS. 2A and 2B are isometric views of a deformable structure 200 with SMM in a non-uniform auxetic pattern and an inflatable sleeve. Specifically, FIG. 2A depicts the deformable structure 200 in a non-deformed state before the application of 1) an activation input (e.g., an electrical current) and 2) a deforming force (e.g., resulting from inflating the inflatable structure), and FIG. 2B depicts the deformable structure 200 in a deformed state following the application of 1) the activation input and 2) the deforming force. For simplicity, heating elements 104 and 106 have been omitted in FIG. 2B.

As described above, the inflatable structure that provides the deforming force may take various forms. In the example depicted in FIGS. 2A and 2B, the inflatable structure is a sealed sleeve. Specifically, the sealed sleeve includes an inner barrier 218 wrapped around an inner surface of the expandable tube 102 and an outer barrier 216 wrapped around an outer surface of the expandable tube. Further in this example, the ends 220-1 and 220-2 of the sleeve may be sealed. The inner barrier 218 and the outer barrier 216 may be sealed to one another and/or the ends 220-1 and 220-2. Put another way, the sealed sleeve may be a closed-ended cylinder with a dual-layer cylindrical wall. In this example, the heating elements 104 and 106 and the expandable tube 102 may be positioned between the dual layers (i.e., the inner barrier 218 and the outer barrier 216).

In an example, the barriers 216 and 218 may be formed of any suitable material. For instance, in some arrangements, the barriers 216 and 218 may be formed out of a flexible, pliable, stretchable, and/or compliant material such as silicon to accommodate the changes to the shape of the expandable tube 102. That is, as the expandable tube 102 deforms/bends, the stretchable barriers 216 and 218 similarly deform to facilitate the expansion without restricting expansion. In an example, the barriers 216 and 218 are formed of a fabric. In an example, the barriers 216 and 218 are formed of a material that is fluidly impermeable. As such, the inner volume of the sealed sleeve may be fluid impermeable. In such a case, the sealed sleeve can be inflated with air and retain the air without allowing the air to escape through the material of the sleeve. As described, the sealed sleeve is inflatable. Thus, the sleeve can include one or more hoses 110 and/or ports to allow air or other fluid to be delivered to and/or released from the sleeve. Specifically as depicted in FIGS. 2A and 2B, the sleeve may include an inlet hose 110-1 and an outlet hose 110-2.

As with the example depicted in FIGS. 1A and 1B, the deformable structure 200 depicted in FIGS. 2A and 2B includes an expandable tube 102 of an SMM material arranged in an auxetic pattern. When an activation input is provided via the heating elements 104 and 106 formed between the inner barrier 218 and the outer barrier 216, the SMM changes from a rigid state to a morphable, deformable, or pliable state. Responsive to a deforming force (i.e., the introduction of pressurized air into the sealed sleeve), the expandable tube 102 may deform. In the example depicted in FIGS. 2A and 2B, the deforming force is an outwardly directed force resulting from air or another fluid being pumped into the cavity of the sealed sleeve and causing the flexible walls to expand.

As in the previous example, the SMM may be such that it returns to its original state and form when re-activated. As described above, the expandable tube 102 may be arranged in an auxetic pattern to exhibit a bending deformation, as depicted in FIG. 2B. Specifically, the SMM in an outer region 112 of the expandable tube 102 may have a less constrained auxetic pattern, and the SMM in an inner region 114 of the expandable tube 102 may have a more constrained auxetic pattern.

As in the example depicted in FIGS. 1A and 1B, in this example, the deformable structure 200 includes a first heating element 104, and in some cases a second heating element 106, within an interior volume of the expandable tube 102. In a particular example, the heating elements (i.e., the first heating element 104 and the second heating element 106) may be attached to the inflatable structure. Specifically, the heating elements 104 and 106 may be formed between the inner barrier 218 and the outer barrier 216. While FIGS. 2A and 2B depict the heating elements 104 and 106 on an inside surface of the expandable tube 102 (i.e., between the inner barrier 218 and the expandable tube 102), the heating elements 104 and 106 may be on an outside surface of the expandable tube 102 (i.e., between the outer barrier 216 and the expandable tube 102). As depicted in FIG. 2A, the heating elements 104 and 106 may form a cylindrical structure adjacent to the cylindrical structure of the expandable tube 102.

As described above, when in a deformable and pliable state, the expandable tube 102 may be deformed by an applied force. In an example, the deforming force is a force that pushes out on the expandable tube 102 from the interior. As such, the deformable structure 200 may include an inlet hose 110-1 through which the air or other fluid may be introduced into the inflatable structure. As air or another fluid is introduced into the sealed sleeve from the inlet hose 110-1, the sealed sleeve expands, generating an outwardly directed force on the walls of the sleeve. This force is transferred to the expandable tube 102, which, because of the applied electrical current from the heating elements 104 and 106, is deformable and expands responsive to the applied force. In an example, air or fluid may be removed from the sealed sleeve, via an outlet hose 110-2.

As described above and as depicted in FIG. 2B, given the auxetic nature of the expandable tube 102, the tube itself expands. Moreover, given the non-uniform nature of the auxetic patterns of the SMM on the expandable tube 102, the tube may expand non-uniformly.

Once the expandable tube is deformed, the activation input from the heating elements 104 and 106 may be disengaged. If the activation input is disengaged while there is still pressurized air in the sealed sleeve, the deformable structure 200 will remain in its deformed shape if the pressurized air is later evacuated. However, if the deforming force is removed (i.e., the pressurized air is released) while the activation input is provided, the deformable structure 200 may return to its undeformed state. Put another way, the SMM remembers its original form (i.e., the elongated form depicted in FIG. 2A) and will return to such when an activation input is applied without a deforming force. The application of the deforming force when the activation energy is applied allows the deformable structure 200 to change shape.

FIG. 3 is a top view of a planar layer 303 of SMM material in a non-uniform auxetic pattern. Specifically, FIG. 3 depicts the expandable tube 102 in an unrolled form. That is, a planar layer 303 of SMM material may be rolled to form the expandable tube 102 of the deformable structures 100 and 200. Additional details regarding the formation of the expandable tube 102 of SMM are provided at the end of the description in FIG. 3.

As described above, the expandable tube 102 (and the auxetic planar layer 303 of SMM material from which the expandable tube 102 is formed) is formed of different combinations of unit cell structures. That is, the expandable tube 102 (and the auxetic planar layer 303 of SMM material from which the expandable tube 102 is formed) is divided into regions 322. Portions of the SMM in the different regions 322-1, 322-2, and 322-3 are arranged into different auxetic patterns. Responsive to an activation input (e.g., electrical current), the different portions of the SMM deform to different degrees based on the different auxetic patterns, as depicted in FIG. 3.

As depicted in FIG. 3, the SMM material in a first region 322-1 may be less constrained, meaning there is more deformation per unit cell 330 than in the other regions 322-2 and 322-3. Deformation may be defined by the length of the arms 334 that are found within a unit cell 330. A longer arm length provides greater deformation as compared to a shorter arm length. Accordingly, a unit cell 330 that has “greater” deformation relative to another unit cell includes longer SMM arms 334.

In general, individual deformable regions within the layer of SMM material may be designated as a unit cell 330. Each unit cell 330 includes an SMM body 332 with various SMM arms 334 extending therefrom. The physical characteristics of the unit cell 330 (i.e., the SMM body 332 and various SSM arms 334) define the deformative movement of the unit cell 330 and the entire planar layer 303 formed of multiple unit cells 330. For simplicity, a few instances of unit cells 330-1, 330-2, and 330-3, SMM bodies 332-1, 332-2, and 332-3, and SMM arms 334-1 and 334-2 are indicated with reference numbers.

As depicted, a first unit cell 330-1 may include arms 334-1 that have a longer length but are more compacted and curved than the arms 334-2 and 334-3 of more constrained unit cells 330-2 and 330-3. As such, responsive to an applied force (i.e., from inflating a balloon 108 or adding pressurized air to an interior cavity of a sealed sleeve), the arms 334-1 of the first unit cell 330-1 (a less constrained cell) may extend to a greater degree than the arms 334-2 of a second unit cell 330-2 (which is a more constrained cell) as depicted in FIG. 3. That is, each unit cell 330 may have a contracted state 324 and an expanded state 326, with the difference in the relative position of the SMM bodies 332 at least in part defining the expandability of the unit cell 330. For example, a first unit cell 330-1 may have greater deformative capability as compared to the other unit cells 330-2 and 330-3 due to the bodies 332-1 of the first unit cell 330-1 being able to move a greater distance from a compacted state 324-1 to an expanded state 326-1 (as compared to similar components in the second unit cell 330-1), which greater distance is defined by the length of the respective arms 334-1.

By comparison, a second unit cell 330-2 may have a reduced deformative capability, relative to the first unit cell 330-1, due to the bodies 332-2 of the second unit cell 330-2 being able to move a lesser distance from the compacted state 324-2 to an expanded state 326-2 (as compared to similar components in the first unit cell 330-1), which reduced distance is defined by the length of the arms 334-2 in the second unit cell 330-2. That is, the second unit cell 330-2 may have a decreased expandability as compared to the first unit cell 330-1 based on the difference in the potential movement of the respective SMM bodies 332 between the contracted state 324 and expanded 326 and the length of the respective arms 334.

By comparison, a third unit cell 330-3 may have a reduced deformative capability relative to the first unit cell 330-1 and the second unit cell 330-2. This is due, in part, to the unit cell-linking arms 336. The unit cell-linking arms 336 prevent the expansion of the unit cell 330-3 in multiple orthogonal directions. As such, the third unit cell 330-3 may have a contracted state 324-3 without a corresponding expanded state. The third unit cell 330-3, which may be referred to as a fully constrained cell, may not expand in size.

Put another way, the first unit cells 330-1, and the first region 322-1 of the planar layer 303 may have a first degree of deformability and the second unit cells 330-2, and the second region 322-2 of the planar layer 303 may have a second degree of deformability that is less than the first degree of deformability. Similarly, the third unit cells 330-3, and the third region 322-3 of the planar layer 303 may have a third degree of deformability that is less than the first degree of deformability and the second degree of deformability.

In an example, the contracted state 324 for each unit cell 330 may be the state that the unit cell 330 returns to when an activation input is applied in the absence of a deforming force. In the context of FIG. 1A-2B, each unit cell 330-1, 330-2, and 330-3 may be in the contracted state 324-1, 324-2, and 324-3 when no activation input and no deforming force is applied as is the case in FIGS. 1A and 2A. By comparison, when the activation input is received and the inflatable structure is activated, the first and second unit cells 330-1 and 330-2 may expand to the relative expanded state 326-1 and 326-2 as depicted in FIGS. 1B and 2B, while the third unit cell 330-3, on account of being fully constrained, remains in the contracted state 324-3 as depicted in FIGS. 1B and 2B.

In the context of a target bending motion as depicted in FIG. 1A-2B, the SMM in a first region 322-1 (i.e., corresponding to the outer region 112 of a bending joint of the expandable tube 102) may be arranged in a first auxetic pattern that deforms to a first degree. The SMM in a third region 322-3 (i.e., corresponding to the inner region 114 of the bending joint of the expandable tube 102) may be arranged in a second auxetic pattern that deforms to a second degree that is less than the first degree. The SMM in a second region 322-2 (i.e., corresponding to the side regions of the bending joint of the expandable tube 102) may be arranged in a third auxetic pattern that deforms to a third degree that is greater than the second degree and less than the first degree. Accordingly, when heat is applied, the SMM in the first region 322-1 may expand more than the SMM in the third region 322-3 based on the first region 322-1 having an auxetic arrangement that facilitates greater deformation than the auxetic arrangement in the third region 322-3. Put another way, when formed into a tubular shape, the SMM in the first region 322-1 (i.e., the less constrained region) on one edge of the expandable tube 102 may deform more than the SMM in the third region 322-3 (i.e., the more constrained region) on the opposite edge of the expandable tube 102 such that the expandable tube may exhibit a bending motion as depicted in FIG. 1A-2B.

Turning now to the formation of the SMM material. The expandable tube 102 may be formed of any suitable SMM. In one specific example, the SMM may include a combination of a liquid epoxy resin, a curing agent, and a modifying agent. An example of a liquid epoxy resin is diglycidyl ether of bisphenol A. An example of a curing agent is poly(propylene glycol) bis(2-aminopropyl ether). An example of a modifying agent is neopentyl glycol diglycidyl ether. While particular SMM compositions are described, other SMM may be used in accordance with the principles described herein.

The expandable tube may be formed in various ways as well. In one example, the layer of SMM material is three-dimensionally printed. In another example, liquid SMM material is poured into a mold (having the auxetic pattern) and left to cure. In yet another example, a slab of SMM substrate is cut into the auxetic pattern shape, for example via a laser cutter or water jet. In another example, a fabric is cut in the particular auxetic pattern (by, for example, laser cutting). Liquid SMM material may then be absorbed into the fabric. Once the SMM is cured, the impregnated fabric exhibits the shape memory behavior described above.

In any case, the SMM may be formed into a planar structure. After fabricating the structure in the planar form, the structure is heated above its glass transition temperature, Tg (e.g., between 70-75 degrees C.), and rolled into a tubular form. In one example, the edge portions 328-1 and 328-2 may be structured to overlap with one another. That is, a first edge 328-1 and a second edge 328-2 may have a reduced thickness that complements one another, resulting in an overall thickness that matches the thickness of the other portions of the expandable tube 102. Unit cells 330 along the first edge 328-1 and 328-2 may then be joined together, for example via adhesive, to form a continuous cross-sectional shape.

FIGS. 4A and 4B are views of the planar layer 303 of SMM material in a non-uniform auxetic pattern and respective heating elements 104 and 106. Specifically, FIG. 4A is a top view of a planar layer 303 of SMM material before its formation into a tube, and FIG. 4B is a perspective view of the expandable tube 102 with the heating elements 104 and 106 formed therein. In general, the heating elements 104 and 106 are electrical wires that heat up responsive to an applied electrical current from a power source. The heating is transmitted to the adjacent SMM to instigate a change in the deformability of the SMM.

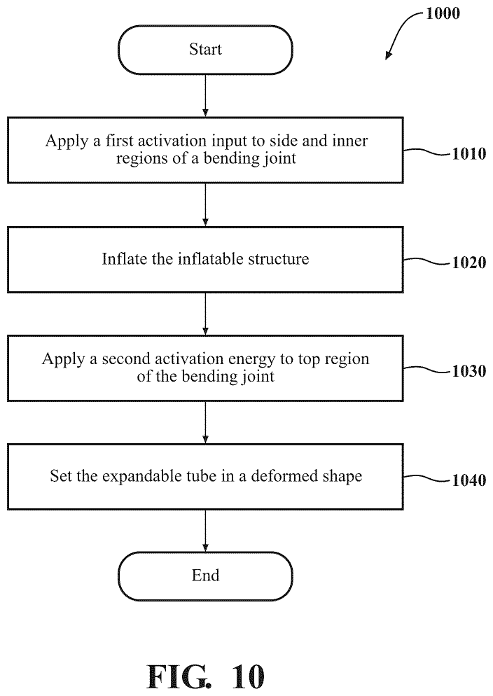

In an example, the heating elements 104 and 106 are separated from one another such that each may be controlled separately. For example, as described below in connection with FIG. 10, it may be desirable to heat certain regions (e.g., an inner region 114 of a bending joint) before heating other regions (e.g., 1) an outer region 112 of the bending joint and 2) side regions between the inner region 114 and the outer region 112). While specific reference is made to a particular sequential heating operation, it may be desirable to heat different regions of the expandable tube 102 with different properties (e.g., different intensities, different periods, and/or different durations) for various reasons. As such, the first heating element 104 may be adjacent to a first region of the expandable tube 102, where the SMM in the first region is arranged in a first auxetic pattern. The deformable structure 100 may also include a second heating element 106 that is adjacent to a second region of the expandable tube 102, where the SMM in the second region is arranged in a second auxetic pattern.

In general, each heating element 104 and 106 may include terminals that connect to the power source such that an activation input (e.g., an electrical current) may be passed therethrough. As depicted in FIG. 4A, each heating element 104 and 106 is arranged in a serpentine pattern in a length direction 448 of the planar layer 303 of SMM and the expandable tube 102. That is, each heating element 104 and 106 extends back and forth between a first longitudinal end of the layer 303 and expandable tube 102 and a second longitudinal end of the layer 303 and the expandable tube 102 a number of times. In addition to serpentining longitudinally, each heating element 104 and 106 may, at least partially, undulate in a transverse direction 446. The undulations in the transverse direction 446 may define the relative expansion/contraction of the expandable tube 102.

Specifically, the first heating element 104 may include a first wire with legs 438-1, 438-2, 438-3, and 438-4 extending longitudinally along the expandable tube 102 in an undulating serpentine pattern. The undulations allow the first heating element and the adjoining portion of the SMM to extend 444 and contract 442.

The second heating element 106 includes a second wire having legs 440-1, 440-2, 440-3, and 440-4 extending longitudinally along the expandable tube 102. Some second wire legs 440-1 and 440-4 are arranged in an undulating serpentine pattern, while other wire legs 440-2 and 440-3 are arranged along a straight path. As described above, due to the undulations, each first heating element leg 438-1, 438-2, 438-3, and 438-4 facilitates extension, with the legs becoming more straight. By comparison, legs 440-2 and 440-3 of the second heating element 106 that are already straight do not give, thus restricting the extension of the associated section of SMM. In the context of a bent motion deformable structures 100 and 200, the first wire legs 438 allow the outer region 112 and side regions to both expand and contract, whereas some of the second heating element legs 440-2 and 440-3 prevent the inner region 114 of the expandable tube 102 from expanding. This characteristic further defines and sharpens the bending motion of the deformable structure 100.

The heating elements 104 and 106 may be formed of various materials. In one example, the heating elements 104 and 106 are formed of a copper or copper-nickel blend. In one example, the heating elements 104 and 106 may be coated. For example, the heating elements 104 and 106 may be polyamide-coated conductive fabric.

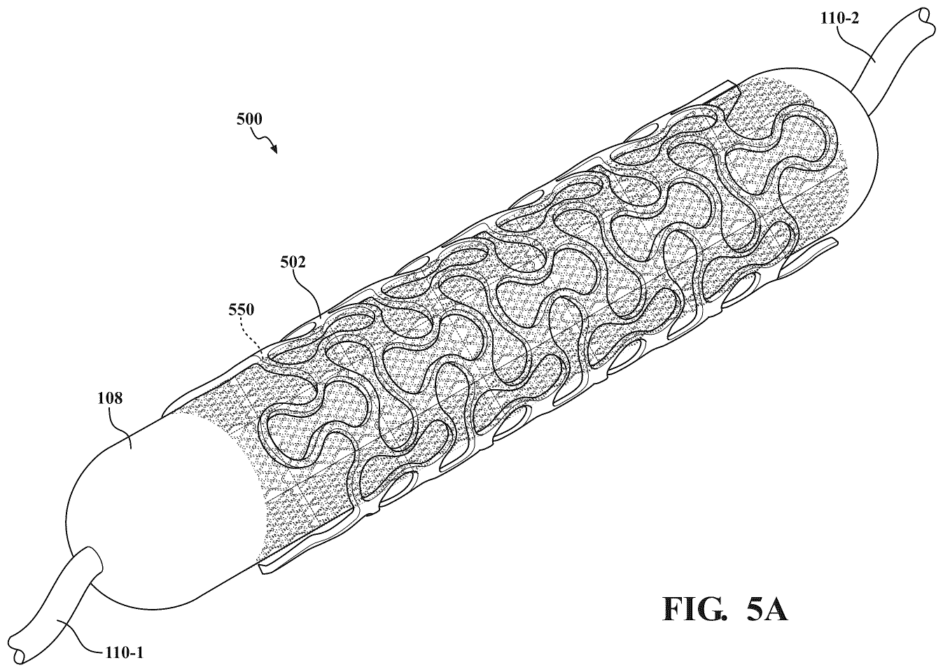

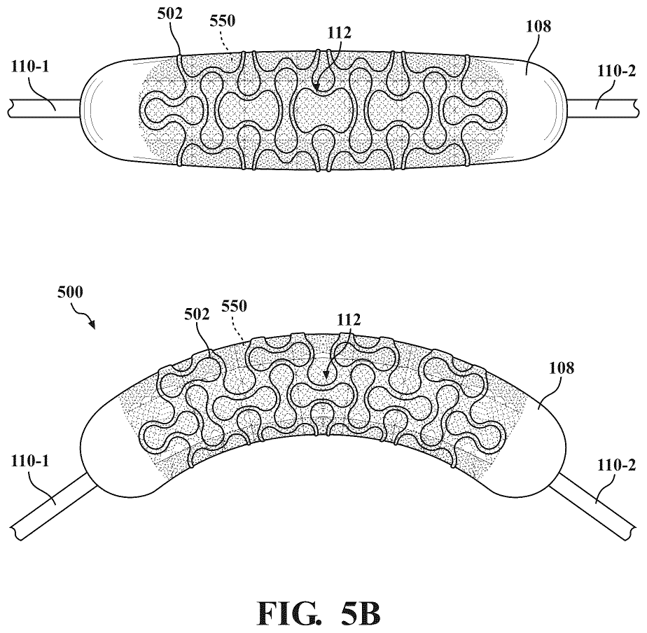

FIGS. 5A and 5B are isometric views of a deformable structure 500 with SMM in a segmented arrangement and an inflatable balloon 108. Specifically, FIG. 5A depicts the deformable structure 500 in a non-deformed state before the application of 1) an activation input (e.g., an electrical current) and 2) a deforming force (e.g., resulting from inflating the inflatable structure), and FIG. 5B depicts the deformable structure 500 in a deformed state following the application of 1) the activation input and 2) the deforming force. For simplicity, FIGS. 5A and 5B omit the heating elements of the segmented structure. Additional details regarding the heating elements of the segments are depicted below in connection with FIG. 7.

As in the examples described above, the deformable structure 500 includes an expandable tube 502 of an SMM material arranged in an auxetic pattern, which SMM becomes deformable responsive to an activation input such as an electrical current. As described above, SMM becomes deformable responsive to an activation input, specifically becoming morphable, deformable, or pliable such that when a deforming force is applied to the expandable tube 502, the expandable tube 502 may change shape responsive to the deforming force. As above, the SMM may be structured such that when the activation input is removed, the SMM returns to a pre-activated/pre-deformed state, in this case, a rigid and stiff state.

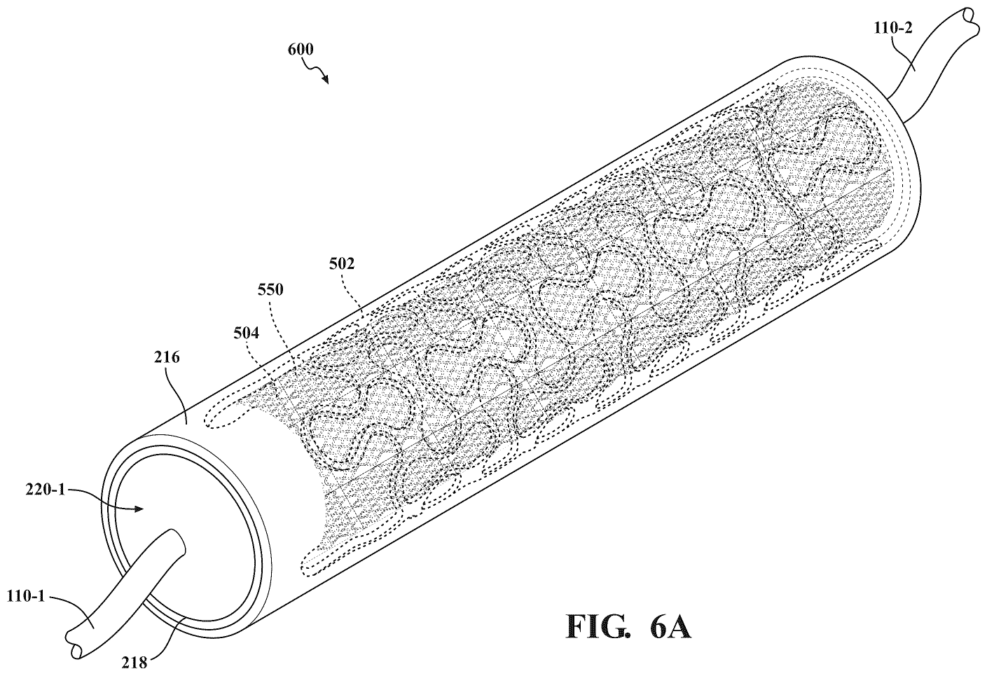

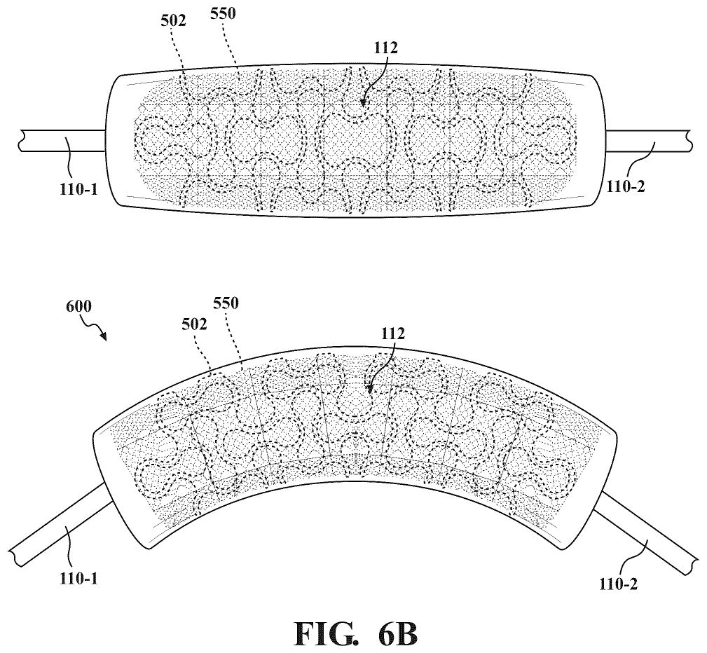

As described above, the expansion of the expandable tube 502 may be controlled to generate a desired deformation to the expandable tube 502. Specifically, the expandable tube 502 may be arranged to exhibit a bending deformation, as depicted in FIG. 5B. As described above, this motion may be facilitated in various ways. In the example depicted in FIG. 5A-6B, this is carried out via individually addressable heating element sections. That is, the expandable tube 502 is divided into segments 550. For simplicity, a single segment 550 is indicated with a reference number. However, the entire surface of the expandable tube 502 may be divided into segments 550. In different examples, the segments 550 may have different sizes. For example, as depicted in FIG. 5A-6B, each segment 550 may correspond to a unit cell of the SMM. In other examples, a segment 550 may correspond to multiple unit cells. In either example, the first heating element (depicted in FIG. 7), and potentially a second heating element, are divided into individually addressable sections corresponding to the segments 550 of the expandable tube 502. Accordingly, a control system may apply the activation energy to particular sections of the expandable tube 502 that correspond to target segments 550, which target segments 550 may correspond to those segments targeted for deformation.

In the context of a bending motion, the target segments 550 may be those found on an outer region 112 of a bending joint. In this example, a power source may deliver an activation input (e.g., electrical current) to the sections of the first heating element that align with the target segments 550. On account of the activation input, these target segments 550 may heat up and become deformable. In contrast, non-target segments, i.e., those segments that align with the inner region and side regions, are not deformable on account of not being activated/heated via the electrical current. Accordingly, bending motion is induced by heating targeted segments 550 on one side of an expandable tube 502 and not heating non-target segments on the opposite side of the expandable tube 502, as depicted in FIG. 5B.

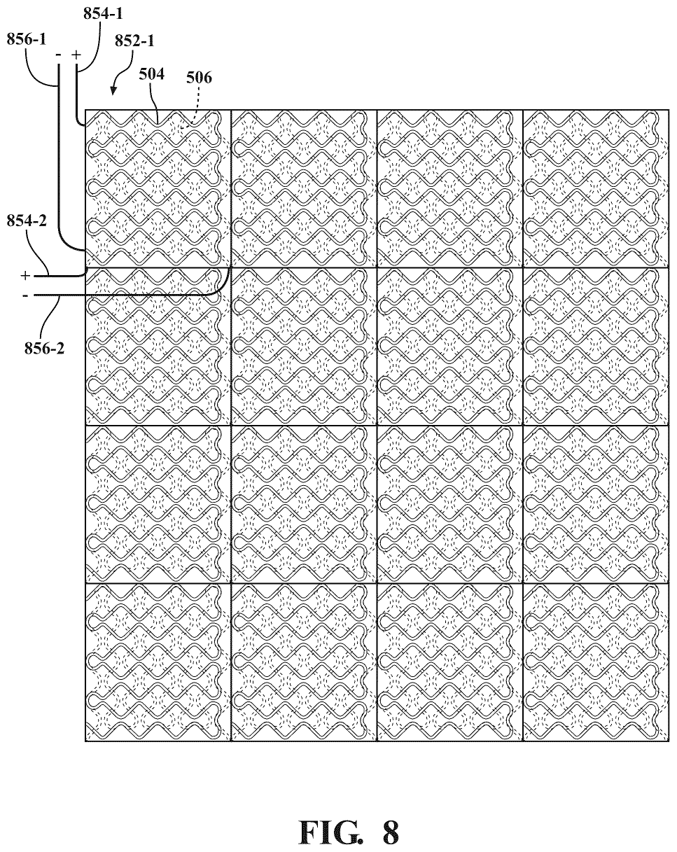

To facilitate the individual addressability of each segment 550, the deformable structure 500 may further include electrical contacts per section of the heating element. The electrical contacts receive the electrical current to heat an associated segment 550 of the expandable tube 502. In particular context of the bending structure, the electrical contacts that align with a target segment 550 to be deformed transmit the electrical current to an associated section of the first heating element that corresponds to the target segment, which target segment to be deformed corresponds to an outer region 112 of a bending joint of the expandable tube 502. Additional details regarding the electrical contacts are provided below in connection with FIG. 8.

As described above, when in a deformable and pliable state, the SMM may be deformed by an applied force. In an example, the deforming force is a force that pushes out on the expandable tube 102 from the interior. Specifically, the deformable structure 500 includes an inflatable structure within the interior volume of the expandable tube 502. The inflatable structure deforms the SMM when the SMM is activated (i.e., from the activation input). The deformable structure 500 may include an inlet hose 110-1 through which the air or other fluid may be introduced into the inflatable structure. The inflatable structure may take various forms. For example, as depicted in FIGS. 5A and 5B, the inflatable structure may be a balloon 108 disposed within the interior volume of the expandable tube 502. As air or another fluid is introduced into the balloon 108 from the inlet hose 110-1, the balloon 108 expands, generating an outwardly directed force on the balloon 108 walls. This force is transferred to the expandable tube 502. Certain segments 550 of the expandable tube 502, on account of the targeted applied electrical current from the heating elements, are deformable and expand responsive to the applied force. In an example, air or fluid may be removed from the balloon 108 via the inlet hose 110-1 or an outlet hose 110-2.

In a particular example, the heating elements may be attached to the inflatable structure. Specifically, the heating elements may be formed or adhered to an interior surface of the balloon 108. In another example, the heating elements may be formed or adhered to an exterior surface of the balloon 108. In yet another example, the heating elements may be formed within the thickness of the balloon 108.

As above, once in a deformed state, the activation input from the heating elements may be disengaged. If the activation input is disengaged while the balloon 108 is still inflated, the deformable structure 500 will remain in its deformed shape if the balloon 108 is later deflated. However, if the deforming force is removed (i.e., the balloon 108 is deflated) while the activation input is provided, the deformable structure 500 may return to its undeformed state. Put another way, the SMM remembers its pre-activated form (i.e., the elongated form depicted in FIG. 5A) and will return to such when an activation input is applied without a deforming force. The application of the deforming force when the activation energy is applied allows the deformable structure 500 to change shape.

FIGS. 6A and 6B are isometric views of a deformable structure 600 with SMM in a segmented arrangement and an inflatable sleeve. Specifically, FIG. 6A depicts the deformable structure 600 in a non-deformed state before the application of 1) an activation input (e.g., an electrical current) and 2) a deforming force (e.g., resulting from inflating the inflatable structure), and FIG. 6B depicts the deformable structure 600 in a deformed state following the application of 1) the activation input and 2) the deforming force.

As described above, the inflatable structure that provides the deforming force may take various forms. In the example depicted in FIGS. 6A and 6B, the inflatable structure is a sealed sleeve. Specifically, the sealed sleeve includes an inner barrier 218 wrapped around an inner surface of the expandable tube 102 and an outer barrier 216 wrapped around an outer surface of the expandable tube. Further in this example, the ends 220-1 and 220-2 may be sealed. The inner barrier 218 and the outer barrier 216 may be sealed to one another and/or the ends 220-1 and 220-2. Put another way, the sealed sleeve may be a closed-ended cylinder with a dual-layer cylindrical wall. In this example, the heating element 504, and in some cases a second heating element, and the expandable tube 502 may be positioned between the dual layers (i.e., the inner barrier 218 and the outer barrier 216).

As with the example depicted in FIGS. 5A and 5B, the deformable structure 600 depicted in FIGS. 6A and 6B include an expandable tube 502 of an SMM material arranged in a uniform auxetic pattern with individually addressable segments 550. When an activation input is provided from a heating element 504 to a target segment 550 formed between the inner barrier 218 and the outer barrier 216, the SMM in the target segment 550 changes from a rigid state to a morphable, deformable, or pliable state. Responsive to a deforming force (i.e., the introduction of pressurized air into the sealed sleeve), the expandable tube 502 may deform, specifically the target segments 550 that have been activated. In the example depicted in FIGS. 6A and 6B, the deforming force is an outwardly directed force resulting from air being pumped into the cavity of the sealed sleeve that causes the flexible walls to expand.

As in the example depicted in FIGS. 2A and 2B, in this example, the deformable structure 600 includes a heating element 504 within an interior volume of the expandable tube 502. In a particular example, the heating element 504 may be attached to the inflatable structure. Specifically, the heating element 504 may be formed between the inner barrier 218 and the outer barrier 216. While FIGS. 6A and 6B depict the heating element 504 on the inside of the expandable tube 502 (i.e., between the inner barrier 218 and the expandable tube 502), the heating element 504 may be on the outside of the expandable tube 502 (i.e., between the outer barrier 216 and the expandable tube 502).

As described above, when in a deformable and pliable state, the expandable tube 502 may be deformed by an applied force. In an example, the deforming force is a force that pushes out on the expandable tube 502 from the interior. The deformable structure 600 may include an inlet hose 110-1 through which the air or other fluid may be introduced into the inflatable structure. As air or another fluid is introduced into the sealed sleeve from the inlet hose 110-1, the sealed sleeve expands, generating an outwardly directed force on the walls of the sleeve. This force is transferred to the expandable tube 502, which, because of the applied electrical current from the heating element 504, is deformable and expands responsive to the applied force. In an example, air or fluid may be removed from the sealed sleeve, via the inlet hose 110-1 or an outlet hose 110-2.

Once the expandable tube 502 is deformed, the activation input from the heating element 504 may be disengaged. If the activation input is disengaged while there is still pressurized air in the sealed sleeve, the deformable structure 600 will remain deformed and may continue if the pressurized air is later evacuated. However, if the deforming force is removed (i.e., the pressurized air is released) while the activation input is provided, the deformable structure 600 may return to its undeformed state. Put another way, the SMM remembers its original form (i.e., the elongated form depicted in FIG. 6A) and will return to such when an activation input is applied without a deforming force. The application of the deforming force when the activation energy is applied allows the deformable structure 600 to change shape.

FIG. 7 is an exploded view of a segment 550 of a deformable structure 500. As described above, the expandable tube 502 may be divided into segments 550, with the portion of the expandable tube 502 within each segment 550 being individually addressable. As depicted in FIG. 7, in an example, the deformable structure 500 includes a first heating element 504 per segment 550, which is between an outer surface of the expandable tube 502 and an outer barrier 216 that surrounds the outer surface. The deformable structure 500 may include a second heating element 506 between an inner surface of the expandable tube 502 and an inner barrier 218 that surrounds the inner surface. In an example, the first heating element 504 may be arranged in an undulating serpentine pattern. The second heating element 506 may also be arranged in an undulating serpentine pattern, with the second heating element 506 pattern being orthogonal to the first heating element 504 pattern. As with the previous heating elements described herein, these tiled heating elements 504 and 506 may be formed of various conductive materials such as copper or a nickel-copper blend. Moreover, as described above, the heating elements 504 and 506 may be coated. As a specific example, the heating elements 504 and 506 may be formed of a polyamide-coated fabric.

FIG. 8 is a top view of sections of an unrolled deformable structure in a segmented arrangement. As described above, in an example, the expandable tube 502 may be formed into segments 550 of SMM, with each segment 550 being individually addressable. To facilitate the individual addressability, the heating elements 504 and 506 may be grouped into sections, with each section corresponding to an associated segment 550 of SMM. FIG. 8 depicts an arrangement of sections, with a single instance of a section 852-1 indicated with a reference number. As described above, each segment 550 may correspond to one or more unit cells. Similarly, each section may correspond to one or more unit cells. Specifically, a first section 852-1 may correspond to and selectively apply an activation input to one or more unit cells. As described above, each section includes first and second heating elements 504 and 506, arranged as depicted in FIG. 7.

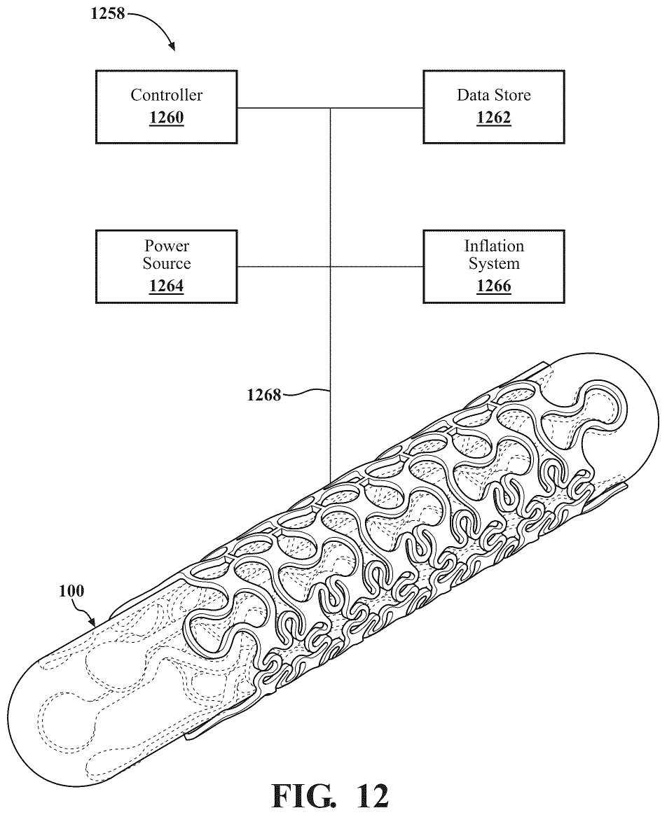

To facilitate the individual addressability of each segment 550, the deformable structure 500 may further include electrical contacts 854 and 856 per section. Specifically, a first section 852-1 may include positive contacts 854-1 and 854-2 for each of the first heating element 504 and the second heating element 506, respectively. The first section 852-1 may also include negative contacts 856-1 and 856-2 for each of the first heating element 504 and 506, respectively. As depicted in FIG. 8, the electrical contacts 854 and 856 are depicted functionally and may physically be routed in a variety of ways. For example, the electrical contacts 854 and 856 for all the sections may be formed on a layer below the first heating and second heating elements 504 and 506. Via these electrical contacts 854 and 856, a power source, such as that depicted in FIG. 12, may individually target particular segments 550 of SMM to activate, which targeting may include passing the activation input through a multiplexer.

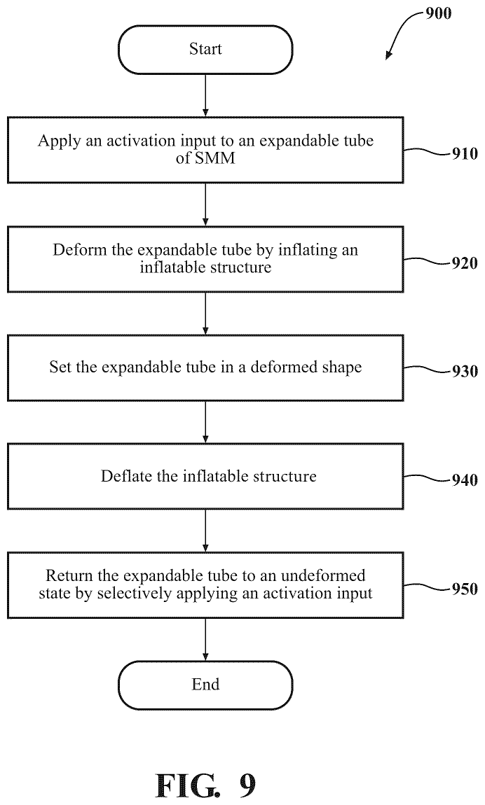

FIG. 9 illustrates a flowchart for one embodiment of a method 900 that is associated with manipulating a deformable structure 100, 200, 500, or 600. In general, it is understood that the methods described herein may be applicable to the arrangements described above, but it is understood that the methods can be carried out with other suitable systems and arrangements. Moreover, the methods may include other steps that are not shown here, and in fact, the methods are not limited to including every step shown. The blocks that are illustrated here as part of the methods are not limited to the particular chronological order. Indeed, some of the blocks may be performed in a different order than what is shown and/or at least some of the blocks shown can occur simultaneously.

At 910, an activation input (e.g., an electrical current) is applied to an expandable tube 102 or 502 of SMM material, which SMM material is arranged in an auxetic pattern. For example, a controller may cause a power source to supply electrical energy to the heating elements 104, 106, 504, or 506. As a result, the heating elements 104, 106, 504, and 506 become heated, as do the adjacent regions of SMM material, which, in turn, causes the SMM to change state. The electrical current may be passed by the heating elements 104 and 106 in the example of a non-uniform auxetic pattern or the heating elements 504 and 506 in the example of the segmented auxetic pattern. In either case, the electrical current provided may have a variety of values, for example, between 0.15 Amperes (A) and 10 A. As another measure, the activation input may have a voltage between 1 Volt (V) and 45 V. The value of the activation input may vary based on the properties of the heating elements 104, 106, 504, or 506 and/or the SMM material itself. Examples of SMM properties that may affect the activation input parameters include target heating temperature, size, shape, thickness, material, etc. of the SMM. As a specific example, the glass transition temperature for the SMM may be 70 degrees Celsius. In this example, the voltage, current, heating duration, etc., may be selected to heat the SMM to a temperature greater than 70 degrees Celsius, in some cases within a target duration. While particular parameters, values, and criteria are referenced, different heating parameters may be selected based on different criteria.

At 920, the expandable tube 102 or 502 may be deformed, specifically by inflating the inflatable structure within the interior volume of the expandable tube 102 or 502, whether the inflatable structure is a balloon 108 or a sealed sleeve. Specifically, air or other fluid from an inflation source can be supplied to the interior of the inflatable structure. In an example, air or other fluid may be provided to reach a target pressure. For example, the air may be provided at 12 pounds per square inch (psi). As described above, during expansion, the expandable tube 102 and 502 may deform to a particular shape and form based on 1) a non-uniform pattern of the auxetic pattern or 2) the location of targeted segments 550, which have been heated.

At 930, the expandable tube 102 and 502 may be set in a deformed shape by disengaging the activation input. That is, as described above when the activation input is discontinued, the SMM returns to a pre-activated state. That is, the SMM returns to a rigid and stiff state. In a non-activated state, the deformed stiff structure does not require the inflatable structure to hold its shape. As such, the deformable structure 100, 200, 500, and 600 may remain deformed and carry a load when cooled below its glass transition temperature, T_{g}.

When desired, the expandable tube 102 or 502 may be returned to an original undeformed shape. Specifically, at 940, the inflatable structure may be deflated. That is, the inflatable structure may be evacuated of air or other fluid. At 950, the expandable tube 102 or 502 may be returned to an undeformed state by selectively applying a second activation input. As described above, the SMM exhibits a property wherein, in the absence of an external force or load, the SMM may return to a previous or memory state. As a result of the material properties of the SMM, re-heating of the SMM in the absence of an external force or load may cause the SMM to relax to a non-activated state. Thus, the SMM can morph into its non-activated condition, as shown in FIGS. 1A, 2A, 5A, and 6A.

Note that while FIG. 9 depicts a particular chronological order for the operations, the operations may be performed in other orders. For example, FIG. 9 describes setting the expandable tube 102 or 502 to a deformable state and then inflating the inflatable structure. In another example, the inflatable structure would be heated after which the deforming activation input could be applied.

FIG. 10 illustrates a flowchart for one embodiment of a method 1000 associated with manipulating a deformable structure 100 and 200 with a non-uniform auxetic pattern. That is, there may be a particular set of operations to enhance the bending motion of an expandable tube 102 with a non-uniform auxetic pattern. In general, the method 1000 includes heating different regions of the non-uniform expandable tube 102 at different points in time. In some cases, heating the inner region 114 and the outer region 112 simultaneously may result in a bulging rather than a bending form. Accordingly, the method 1000 separates the heating of these different regions to enhance the bending motion.

Specifically at 1010, a first activation input (e.g., electrical current) is passed to a heating element that aligns with the inner region 114 of a bending joint. With reference to FIGS. 4A and 4B, this may include applying an electrical current to the second heating element 106, which is aligned with the inner region 114 (the third region 322-3 as depicted in FIG. 3) of the bending joint. During this time, no activation input may be provided to the first heating element 104, which is aligned with the outer region 112 and side regions (the first region 322-1 and second region 322-2 as depicted in FIG. 3) of the bending joint. This “pre-heating” of the inner region 114 results in the corresponding portion of the SMM structure becoming softer and beginning to deform as the inflatable structure is inflated at 1020.

Following inflation of the inflatable structure, at 1030, a second activation input (e.g., a second electrical current) is applied to a heating element that aligns with the SMM on an outer region 112 and side regions of the bending joint. With reference to FIGS. 4A and 4B, this may include applying an activation input to the first heating element 104, which is aligned with the outer region 112 (the first region 322-1 as depicted in FIG. 3) and the side regions (the second regions 322-2 as depicted in FIG. 3) of the bending joint. As described above, this sequencing of the heating elements 104 and 106 reduces the chance of uncontrolled deformation upon heating and inflation. Then, at 1040, and as described above, the expandable tube 102 may be set in a deformed shape by disengaging the activation input.

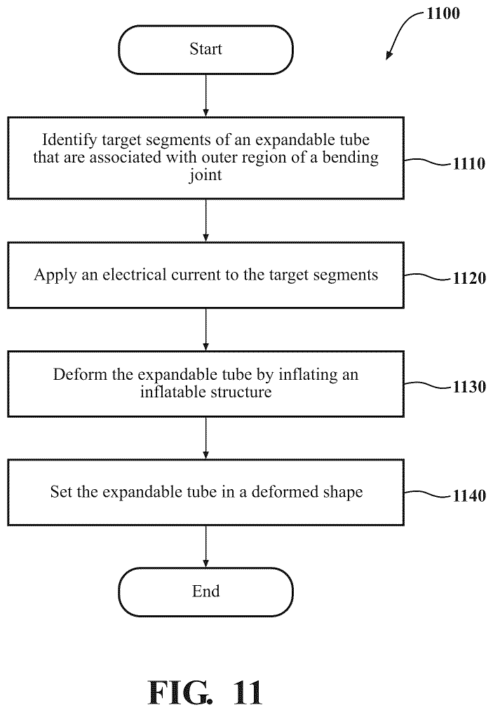

FIG. 11 illustrates a flowchart for one embodiment of a method 1100 that is associated with manipulating a deformable structure 500 and 600 in a segmented arrangement. As described above, in one example a bending motion is facilitated by applying an activation input to targeted segments of the expandable tube 502. Accordingly, in this example, at 1110, target segments of the expandable tube 502 that correspond to an outer region 112 of a bending joint are identified. That is, the method 1100 includes selecting a bending joint for the expandable tube 102 and identifying those segments 550 of the expandable tube 502 that are to be deformed. Specifically, the target segments may be those segments 550 on an outer region 112 of the bending joint, as these segments are those that are to expand to provide the bending motion.

At 1120, the activation input is applied to the target segments, while no activation input is provided to non-target segments. As a result, the state of the target segments is altered to become more pliable while other segments 550 remain rigid and stiff. As a result, at 1130, when the inflatable structure is inflated, the target segments expand while others do not. This results in a bent, deformed shape for the expandable tube 502. Then, at 1140, and as described above, the expandable tube 102 may be set in a deformed shape by disengaging the electrical current.

FIG. 12 depicts a system 1258 for manipulating a deformable structure 100, 200, 500, and 600. Note that while FIG. 12 depicts a particular type of deformable structure, specifically one that includes a balloon 108 and non-uniform expandable tube 102, the system 1258 may be equally applicable with other types of expandable tubes. Specifically, in this example, the system 1258 includes a power source 1264 coupled to the heating elements 104, 106, 504, and 506 to apply the activation input to the SMM and an inflation system 1266 to selectively inflate the inflatable structure.

Note that system 1258 may include various elements. Some of the possible elements of the system 1258 are shown in FIG. 12 and will now be described. It will be understood that it is not necessary for the system 1258 to have all of the elements shown in FIG. 12 or described herein. The system 1258 can have any combination of the various elements shown in FIG. 12. Further, the system 1258 can have additional elements to those shown in FIG. 12. In some arrangements, the system 1258 may not include one or more of the elements shown in FIG. 12. Further, while the various elements may be shown as being located on or within the system 1258 in FIG. 12, it will be understood that one or more of these elements can be located external to the system 1258. Thus, such elements are not located on, within, or otherwise carried by the system 1258. Further, the elements shown may be physically separated by large distances. Indeed, one or more of the elements can be located remote from the other elements of the system 1258.

In an example, the system may include a controller 1260. The controller 1260 may include a processor. “Processor” means any component or group of components that are configured to execute any of the processes described herein or any form of instructions to carry out such processes or cause such processes to be performed. The processor(s) may be implemented with one or more general-purpose and/or one or more special-purpose processors. Examples of suitable processors include microprocessors, microcontrollers, digital signal processors (DSP) processors, and other circuitry that can execute software. Further examples of suitable processors include, but are not limited to, a central processing unit (CPU), an array processor, a vector processor, a DSP, a field-programmable gate array (FPGA), a programmable logic array (PLA), an application specific integrated circuit (ASIC), programmable logic circuitry, and a controller. The processor(s) can include at least one hardware circuit (e.g., an integrated circuit) configured to carry out instructions contained in program code. In arrangements in which there is a plurality of processors, such processors can work independently from each other or one or more processors can work in combination with each other.

The controller 1260 may include computer-readable program code that, when executed by a processor, implements one or more of the various processes described herein. The controller 1260 may include profiles and logic for actively controlling the deformable structure 100, 200, 500, and 600 according to arrangements herein. For example, the controller 1260 may determine when the deformable structure 100, 200, 500, and 600 should be activated or deactivated. Such a determination may be based on different signals, such as sensor signals or user input. The controller 1260 may also direct the power source 1264 and the inflation system 1266 to activate based on a determination that the deformable structure 100, 200, 500, and 600 should be activated or deactivated.

The system 1258 can include one or more data stores 1262 for storing one or more types of data. The data store(s) 1262 can include volatile and/or non-volatile memory. Examples of suitable data stores 1262 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 1262 can be a component of the controller 1260, or the data store(s) 1262 can be operatively connected to the controller 1260 for use thereby. The term “operatively connected,” as used throughout this description, can include direct or indirect connections, including connections without direct physical contact.

The data store(s) 1262 can store one or more actuation profiles for the deformable structure 100, 200, 500, and 600. Such profiles can include desired actuation sequences, timing information, etc. The data store(s) 1262 can include material data about the SMM.

The system 1258 can include one or more power sources 1264. The power source(s) 1264 can be any power source capable of and/or configured to energize the heating elements. For example, the power source(s) 1264 can include a battery.

The system 1258 can include one or more inflation systems 1266. An inflation system 1266 may include an inflation source. The inflation source(s) may be any source of air or other suitable gas and/or fluid for inflating the inflatable structure. As an example, the inflation source(s) may be an air tank. In some arrangements, the inflation source(s) can be configured to maintain a constant fluid pressure in the balloon 108 or sealed sleeve. In some implementations, the inflation system 1266 includes a pump. In some arrangements, the inflation source(s) can include a gas canister capable of delivering a compressed gas.

The various elements of the system 1258 can be communicatively linked to one another or one or more other elements through one or more communication networks 1268. As used herein, the term “communicatively linked” can include direct or indirect connections through a communication channel, bus, pathway or another component or system. A “communication network” means one or more components designed to transmit and/or receive information from one source to another. The data store(s) 1262 and/or one or more other elements of the system 1258 can include and/or execute suitable communication software, which enables the various elements to communicate with each other through the communication network and perform the functions disclosed herein. In an example, the communication network can include wired communication links and/or wireless communication links.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-12, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a computer-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. A non-exhaustive list of the computer-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a computer-readable storage medium is, for example, a tangible medium that stores a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A deformable structure, comprising:
an expandable tube of a shape memory material (SMM) arranged in an auxetic pattern, the SMM becomes deformable responsive to an activation input;
a first heating element, within an interior volume of the expandable tube, to activate the SMM; and
an inflatable structure, within the interior volume of the expandable tube, to selectively deform the SMM when activated.

2. The deformable structure of claim 1, wherein the inflatable structure comprises at least one of:
a balloon disposed within the interior volume of the expandable tube; or
a sealed sleeve comprising:
an inner barrier wrapped around an inner surface of the expandable tube; and
an outer barrier wrapped around an outer surface of the expandable tube, ends of the sealed sleeve are sealed, forming an interior cavity.

3. The deformable structure of claim 1, wherein the first heating element is attached to the inflatable structure.

4. The deformable structure of claim 1, wherein:
the expandable tube is divided into regions;
portions of the SMM in different regions are arranged in different auxetic patterns; and
responsive to the activation input, different portions of the SMM deform to different degrees based on the different auxetic patterns.

5. The deformable structure of claim 4, wherein:
the first heating element is adjacent to a first region of the expandable tube;
the SMM in the first region is arranged in a first auxetic pattern;
the deformable structure further comprises a second heating element adjacent to a second region of the expandable tube; and
the SMM in the second region is arranged in a second auxetic pattern.

6. The deformable structure of claim 5, wherein:
the first heating element comprises a first wire having legs extending longitudinally along the expandable tube in an undulating serpentine pattern; and
the second heating element comprises a second wire having two legs extending longitudinally along the expandable tube, a first leg of the second wire arranged in an undulating serpentine pattern and a second leg of the second wire arranged along a straight path.

7. The deformable structure of claim 4, wherein:
the SMM in an outer region of a bending joint of the expandable tube is arranged in a first auxetic pattern that deforms to a first degree;
the SMM in an inner region of the bending joint is arranged in a second auxetic pattern that deforms to a second degree that is less than the first degree; and
the SMM in side regions of the bending joint is arranged in a third auxetic pattern that deforms to a third degree that is greater than the second degree and less than the first degree.

8. The deformable structure of claim 1, wherein:
the expandable tube is divided into segments;
the first heating element is divided into individually addressable sections that correspond to the segments of the expandable tube; and
the deformable structure further comprises electrical contacts per section, the electrical contacts to receive the activation input to heat an associated segment of the expandable tube.

9. The deformable structure of claim 8, wherein:
contacts that align with a target segment to be deformed transmit the activation input to an associated section of the first heating element that corresponds to the target segment; and
the target segment to be deformed corresponds to an outer region of a bending joint of the expandable tube.

10. The deformable structure of claim 8, wherein:
the first heating element is between an outer surface of the expandable tube and an outer barrier that surrounds the outer surface; and
the inflatable structure further comprises a second heating element between an inner surface of the expandable tube and an inner barrier that surrounds the inner surface.

11. A system, comprising:
a deformable structure, comprising:
an expandable tube of a shape memory material (SMM) arranged in an auxetic pattern, the SMM becomes deformable responsive to an electrical current;
a first heating element, within an interior volume of the expandable tube, to activate the SMM; and
an inflatable structure, within the interior volume of the expandable tube, to selectively deform the SMM when activated;
a power source coupled to the first heating element to apply the electrical current to the SMM; and
an inflation system to selectively inflate the inflatable structure.

12. The system of claim 11, wherein the inflatable structure comprises at least one of:
a balloon disposed within the interior volume of the expandable tube; or
a sealed sleeve comprising:
an inner barrier wrapped around an inner surface of the expandable tube; and
an outer barrier wrapped around an outer surface of the expandable tube, ends of the sealed sleeve are sealed, forming an interior cavity.

13. The system of claim 11, wherein:
the expandable tube is divided into regions;
portions of the SMM in different regions are arranged in different auxetic patterns; and responsive to the electrical current, different portions of the SMM deform to different degrees based on the different auxetic patterns.

14. The system of claim 13, wherein:
the first heating element:
is adjacent a first region of the expandable tube; and
comprises a first wire having legs extending longitudinally along the expandable tube in an undulating serpentine pattern; and
the deformable structure further comprises a second heating element that:
is adjacent a second region of the expandable tube; and
comprises a second wire having two legs extending longitudinally along the expandable tube, a first leg of the second wire arranged in an undulating serpentine pattern and a second leg of the second wire arranged along a straight path.

15. The system of claim 13, wherein:
the SMM in an outer region of a bending joint of the expandable tube is arranged in a first auxetic pattern that deforms to a first degree;
the SMM in an inner region of the bending joint is arranged in a second auxetic pattern that deforms to a second degree that is less than the first degree;
the SMM in side regions of the bending joint is arranged in a third auxetic pattern that deforms to a third degree that is greater than the second degree and less than the first degree;
the first heating element is adjacent to the outer region and the side regions of the bending joint; and
the deformable structure further comprises a second heating element adjacent to the inner region of the bending joint.

16. The system of claim 11, wherein:
the expandable tube is divided into segments;
the first heating element is divided into individually addressable sections that correspond to the segments of the expandable tube; and
the deformable structure further comprises electrical contacts per section, the electrical contacts to receive the electrical current to heat an associated segment of the expandable tube.

17. A method, comprising:
applying an activation input to an expandable tube of shape memory material (SMM) arranged in an auxetic pattern, the SMM becomes deformable responsive to the activation input;
deforming the expandable tube by inflating an inflatable structure that is within an interior volume of the expandable tube; and
setting the expandable tube in a deformed shape by disengaging the activation input.

18. The method of claim 17, further comprising:
deflating the inflatable structure; and
returning the expandable tube to an undeformed state by selectively applying a second activation input to the expandable tube.

19. The method of claim 17, wherein:
applying the activation input to the expandable tube comprises applying a first activation input to a heating element that aligns with the SMM in an inner region of a bending joint of the expandable tube; and
the method further comprises, following inflating the inflatable structure, applying a second activation input to a second heating element that aligns with the SMM in an outer region and side regions of the bending joint, the SMM in the outer region and side regions having different auxetic patterns than each other and then an auxetic pattern of the SMM in the inner region.

20. The method of claim 17:
further comprising selecting a bending joint for the expandable tube; and
wherein applying the activation input to the expandable tube comprises selectively applying the activation input to a target segment of the expandable tube corresponding to an outer region of the bending joint of the expandable tube.
